(19) United States
(12) Patent Application Publication
(10) Pub. No.: US 2024/0320447 A1
(43) Pub. Date: Sep. 26, 2024

(54) DYNAMIC GENERATION OF ENHANCED PROMPT VECTORS FOR LANGUAGE MODELS

(71) Applicant: International Business Machines Corporation, Armonk, NY (US)

(72) Inventors: Tong LIU, Xi'an (CN); Zhong Fang YUAN, Xi'an (CN); Fei WANG, Dalian (CN); Ting Yao LIU, Ningbo (CN); Yu Bin MAO, Beijing (CN); Sen LIANG, Xi'An (CN)

(21) Appl. No.: 18/187,938

(22) Filed: Mar. 22, 2023

(51) Int. Cl. G06F 40/47; G06F 40/247

(52) U.S. Cl. CPC G06F 40/47; G06F 40/247

(57) ABSTRACT

Techniques for dynamic prompt vector generation for improved language model predictions are provided. A textual prompt word and textual context data are received, and an interim vector is generated by encoding the textual prompt word and the textual context data using an encoder machine learning model. An augmented prompt vector is generated by processing the interim vector using a sequence generation machine learning model, the sequence generation machine learning model trained based on at least one sequence of vectors comprising a training prompt word, a training related word, and a plurality of intermediate vectors. Model output is generated by processing the augmented prompt vector using a language machine learning model.

### BACKGROUND

The present disclosure relates to language models, and more specifically, to dynamic generation of augmented prompt vectors for improved model performance.

In various deep learning systems, prompt learning has become an increasingly popular technology. Prompt learning leverages a pre-trained language model and has been shown to exhibit excellent few-sample learning ability (as well as zero-sample learning ability in some cases). However, prompt learning has several significant disadvantages. One such disadvantage relates to the actual use of prompt words themselves. That is, the output of the language model depends significantly on the choice of prompt words. Stated differently, even minor differences of the prompt words (e.g., using synonyms) can cause the output of the model to vary greatly.

Unfortunately, these disadvantages are generally caused by the limitations of prompt learning itself. When a large (language) model is pre-trained, different models will have different attention and sensitivity to different words due to different training data and masking strategies. This phenomenon can cause significant trouble for users in real usage scenarios, forcing users to constantly try different prompt words in order to achieve good or accurate results. This results in generally less accurate language model output, as well as wasted manpower and time.

### SUMMARY

According to one embodiment of the present disclosure, a method is provided. The method includes receiving a textual prompt word and textual context data; generating an interim vector by encoding the textual prompt word and the textual context data using an encoder machine learning model; generating an augmented prompt vector by processing the interim vector using a sequence generation machine learning model, the sequence generation machine learning model trained based on at least one sequence of vectors comprising a training prompt word, a training related word, and a plurality of intermediate vectors; and generating model output by processing the augmented prompt vector using a language machine learning model.

According to one embodiment of the present disclosure, a system is provided. The system includes one or more computer processors, and a memory containing a program which when executed by the one or more computer processors performs an operation. The operation includes receiving a textual prompt word and textual context data; generating an interim vector by encoding the textual prompt word and the textual context data using an encoder machine learning model; generating an augmented prompt vector by processing the interim vector using a sequence generation machine learning model, the sequence generation machine learning model trained based on at least one sequence of vectors comprising a training prompt word, a training related word, and a plurality of intermediate vectors; and generating model output by processing the augmented prompt vector using a language machine learning model.

According to one embodiment of the present disclosure, a computer program product is provided. The computer program product includes a computer-readable storage medium having computer-readable program code embodied therewith, the computer-readable program code executable by one or more computer processors to perform an operation. The operation includes receiving a textual prompt word and textual context data; generating an interim vector by encoding the textual prompt word and the textual context data using an encoder machine learning model; generating an augmented prompt vector by processing the interim vector using a sequence generation machine learning model, the sequence generation machine learning model trained based on at least one sequence of vectors comprising a training prompt word, a training related word, and a plurality of intermediate vectors; and generating model output by processing the augmented prompt vector using a language machine learning model.

### BRIEF DESCRIPTION OF THE DRAWINGS

FIG. 1 depicts an example computing environment for the execution of at least some of the computer code involved in performing the inventive methods.

FIG. 2 depicts an example workflow for generating related words based on prompt words, according to one embodiment disclosed herein.

FIG. 3A depicts an example workflow for generating a sequence of vectors based on a prompt word and a related word, according to one embodiment disclosed herein.

FIG. 3B depicts an example workflow for training a sequence generation model using a sequence of vectors, according to one embodiment disclosed herein.

FIG. 4 depicts an example workflow for generating augmented prompt vectors and language model output, according to one embodiment disclosed herein.

FIG. 5 is a flow diagram depicting an example method for training machine learning models to generate augmented prompt vectors, according to one embodiment disclosed herein.

FIG. 6 is a flow diagram depicting an example method for using machine learning models to generate augmented prompt vectors and language model output, according to one embodiment disclosed herein.

FIG. 7 is a flow diagram depicting an example method for generating augmented prompt vectors and language model output, according to one embodiment disclosed herein.

### DETAILED DESCRIPTION

Embodiments of the present disclosure provide techniques for enhanced or augmented prompt vector generation in order to improve the accuracy and reliability of language models.

In some embodiments, a dynamic generation technique of the prompt vector is provided, which can effectively avoid the problems of conventional language models where the prompt use process/model output is unstable. In so doing, embodiments of the present disclosure can substantially improve the model accuracy, as well as reduce the costs of prompt trial and error, further enabling the language models to operate more efficiently (e.g., to generate accurate output with fewer computing resources, as the user need not experiment with multiple prompts).

In some embodiments of the present disclosure, information extraction using language models is used as one example application of the dynamic augmented prompt generation described herein. However, embodiments of the present disclosure are readily applicable to any language model architecture. As an example, consider an information extraction model trained based on prompt learning, where the language model receives a prompt word (referred to in some embodiments as the prompt, the text prompt, the textual prompt, the textual prompt word, and the like) (e.g., “amount” or “dosage”) and contextual data (referred to in some embodiments as the context, the text context, the textual context, the context data, the textual context data, and the like) (e.g., a set of text to search based on the prompt) and outputs relevant information from the contextual data. For example, if the context includes a string such as “antibiotics: 30 mg,” given a prompt such as “amount,” the model may output text for identified dosages or amounts in the context data, such as “30 mg”.

In many conventional language models, the prompt “amount” may accurately output this information with high confidence while the prompt “dosage” may fail to identify any relevant text. That is, because the language model is generally trained on a generic dataset (e.g., not a medical-specific set), the term “amount” is likely far more common in the training data than the term “dosage.” Accordingly, the language model often fails to adequately learn or understand the concept of “dosage,” and so fails to generate accurate output given this prompt. By using embodiments of the present disclosure to generate augmented prompts, however, the language model may generate similar or identical output with high confidence, regardless of whether “dosage” or “amount” is used as the prompt.

In some embodiments, one factor that contributes to the instability of the prompt process for language models is the distinction between “sufficient” and “insufficient” degrees of learning in the pretrained language model. For example, if information on the word “amount” and a “unit of measure” type are often found in the same context in the training data/pretrained language model, the model will learn that “amount” and “unit of measure” have some correlation during the training. In the process of prompting (e.g., runtime inferencing/use), more accurate results are generated when using “amount” as the prompt word. However, other words such as “dosage,” which is generally synonymous with amount, cause the model to fail because such words are relatively niche or less common, and are not learned sufficiently in the training process of the pretrained language model. Accordingly, the model cannot determine the association between the word “dosage” and the unit of measure information. In this way, two semantically similar prompt words result in tremendously different outputs.

In some embodiments of the present disclosure, therefore, dynamic generation techniques based on real-time interactive prompt enhancement vectors are provided. In some embodiments, the traditional prompt interaction process is enhanced from the explicit word or phrase level to a dynamically generated implicit vector. This implicit vector may be generated not only from the a priori knowledge of the pre-trained language model, but also from the original prompt word(s) and the context data itself (also referred to in some embodiments as the text to be extracted, the textual context data, and the like), which can greatly improve the robustness of the prompt words/language model output in real time. Embodiments of the present disclosure can significantly improve the robustness of prompt words/language models, so that the user does not need to select and compare prompt words in a granular way to extract the required knowledge efficiently.

In some embodiments, the dynamic generation can be conceptualized as a sequence of three general operations: application of one or more multilingual modal attention mechanisms for prompt words on the context text, highly robust prompt vector generation, and application of the highly robust prompt vector to the language model. Each of these operations is discussed in more detail below.

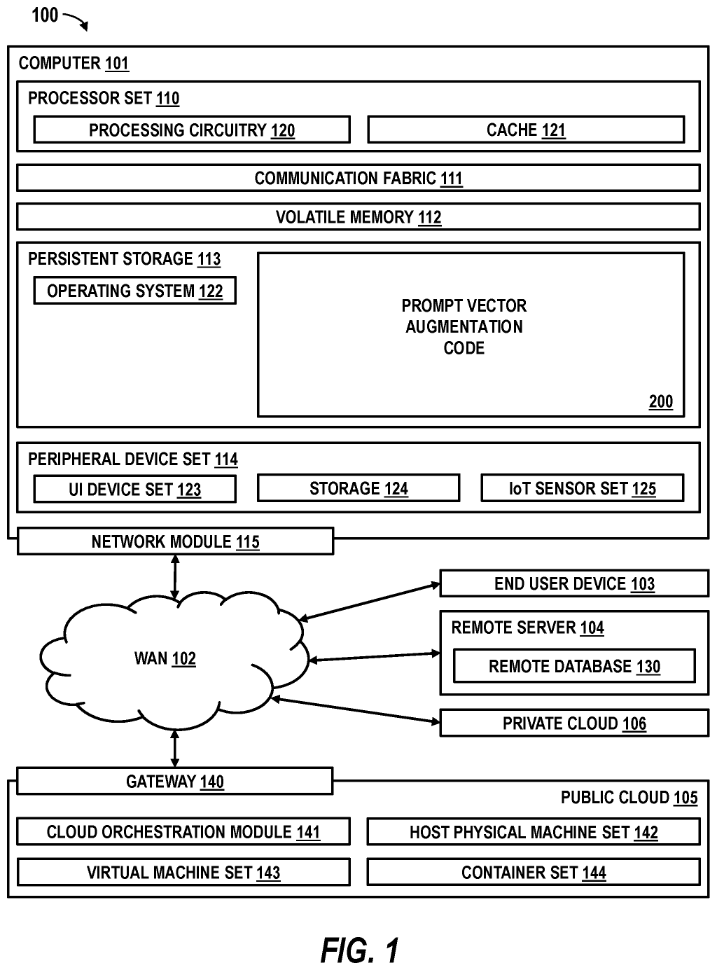

FIG. 1 depicts an example computing environment 100 for the execution of at least some of the computer code involved in performing the inventive methods.

Computing environment 100 contains an example of an environment for the execution of at least some of the computer code involved in performing the inventive methods, such as prompt vector augmentation code 200. In addition to prompt vector augmentation code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and prompt vector augmentation code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in prompt vector augmentation code 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in prompt vector augmentation code 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

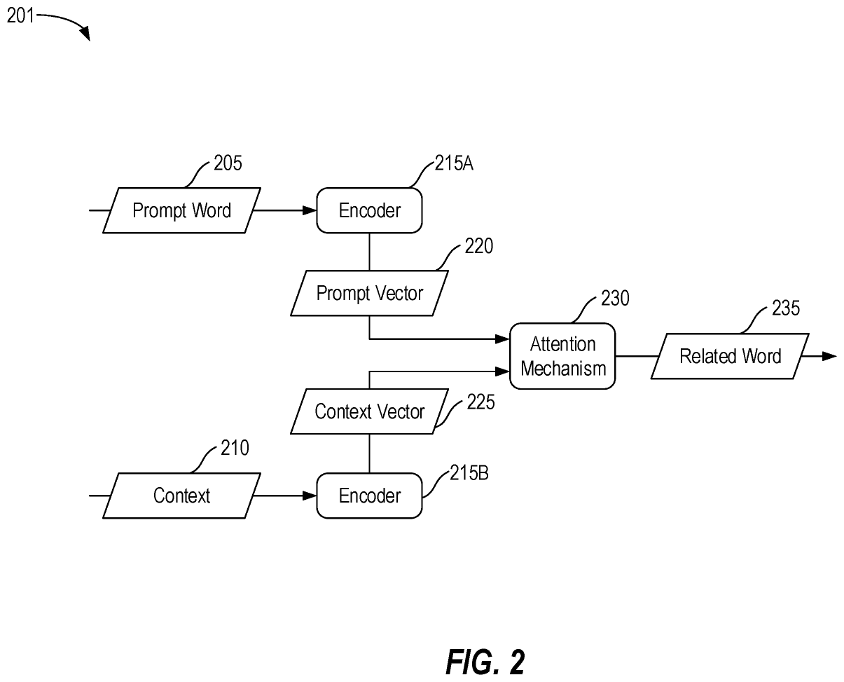

FIG. 2 depicts an example workflow 201 for generating related words based on prompt words, according to one embodiment disclosed herein. In some embodiments, the workflow 201 can be used during a training process to provide augmented prompt vectors. For example, the workflow 201 may be implemented by one or more hardware or software components, such as the prompt vector augmentation code 200 of FIG. 1, to train one or more models to generate augmented prompt vectors. In some embodiments, a first system or component (referred to in some embodiments as a training system) may train the model(s), while a second system or component (referred to in some embodiments as an inferencing system) may use the trained model(s) during runtime to generate model output. In some embodiments, a single system may act as both the training system and the inferencing system.

In some embodiments, the workflow 201 can use an encoder-based architecture (e.g., the encoder of a multilingual translation model) to vectorize the input prompt word and the context text, which can model the text at a multidimensional level. As words that are very different in a first language may be very similar in a second language (and vice versa), the encoding of the multilingual translation model may allow for semantic enhancement of the prompt word and the context text. For example, the process of embedding the prompt word using the encoder of the multilingual translation model may be comparable to inferring different prompt words belonging to multiple languages and the context data at the same time, which can have an enhanced effect on the semantic level. In some embodiments, as discussed in more detail below, after multimodal vectorization, an information interaction network may be used to match the prompt word with the context text (e.g., using an attention mechanism), with the aim of finding or outputting the most relevant word(s), in the context text, to the prompt word.

In the illustrated example, a prompt word 205 is provided to an encoder 215A (referred to in some embodiments as an encoder machine learning model) to generate a prompt vector 220. As discussed above, the prompt word 205 can generally correspond to a textual word or phrase (e.g., natural language text) to be used to prompt a language model to generate output. In some embodiments, the encoder 215A corresponds to the encoder portion of a pretrained encoder-decoder model. For example, as discussed above, the encoder may be trained to generate a vector representation of text, and this vector representation may be processed by a decoder (referred to in some embodiments as a decoder machine learning model) to generate output. In some embodiments, as discussed above, the encoder 215A is a portion of a pretrained multilanguage translation model (e.g., a model trained to translate input text from one or more languages to one or more different languages). The prompt vector 220 is generally representative of the prompt word 205, potentially with enhanced semantics (e.g., generated or added based on the learning of the encoder 215A). In some embodiments, the multilanguage model may be referred to as a translation machine learning model.

In the illustrated example, context 210 is also provided as input to an encoder 215B to generate a context vector 225. As discussed above, the context 210 can generally correspond to text data (e.g., natural language text) to be searched/evaluated based on the prompt word 205 (using a language model) to generate output. In some embodiments, the encoder 215B is the same as the encoder 215A. That is, the encoder 215B may be a copy or instance of the encoder 215A, and/or the encoders 215 may use the same parameters. The context vector 225 is generally representative of the context 210, potentially with enhanced semantics (e.g., generated or added based on the learning of the encoder 215B).

As illustrated, the prompt vector 220 and context vector 225 are then provided to an attention mechanism 230 which uses one or more attention techniques to generate a related word 235. In some embodiments, the attention mechanism 230 is a multi-head attention mechanism and/or a self-attention mechanism. In some embodiments, the attention mechanism 230 is a neural network model. In at least one embodiment, the attention mechanism 230 is a pretrained model. That is, in some embodiments, the training system need not train or refine the parameters of the attention mechanism 230.

As discussed above, the attention mechanism 230 may generally evaluate the prompt vector 220 and context vector 225 to identify or generate one or more relevant word(s) to the prompt word 205. In some embodiments, if multiple related words 235 are output, the related word 235 having the highest score (e.g., the highest similarity, the highest confidence, and the like) may be selected. In some embodiments, the attention mechanism 230 selects the related word(s) 235 from a predefined vocabulary of words used during training of the attention mechanism 230. That is, the attention mechanism 230 may be (pre)trained to identify a related word 235 (e.g., the vector of a related word) based on an input prompt vector 220 and context vector 225), such as the word (from the training dictionary) that is most similar to the input (e.g., with the smallest cosine distance).

As discussed in more detail below, the related word 235 can then be used to generate a sequence of vectors that are used to train a sequence generation model (referred to in some embodiments as a sequence generation machine learning model).

Although the illustrated example suggests generation/output of a single related word 235 based on a single prompt word 205 and context 210, in some embodiments, the workflow 201 may be performed multiple times (in sequence or in parallel) to generate multiple such related words 235, one for each prompt word 205. That is, for a set of training data (e.g., a set of records, each including a prompt word 205 and context 210), the workflow 201 may be used during a training phase to generate a corresponding related word 235. These training data records (including the related words) can then be used to train a sequence generation model, as discussed in more detail below.

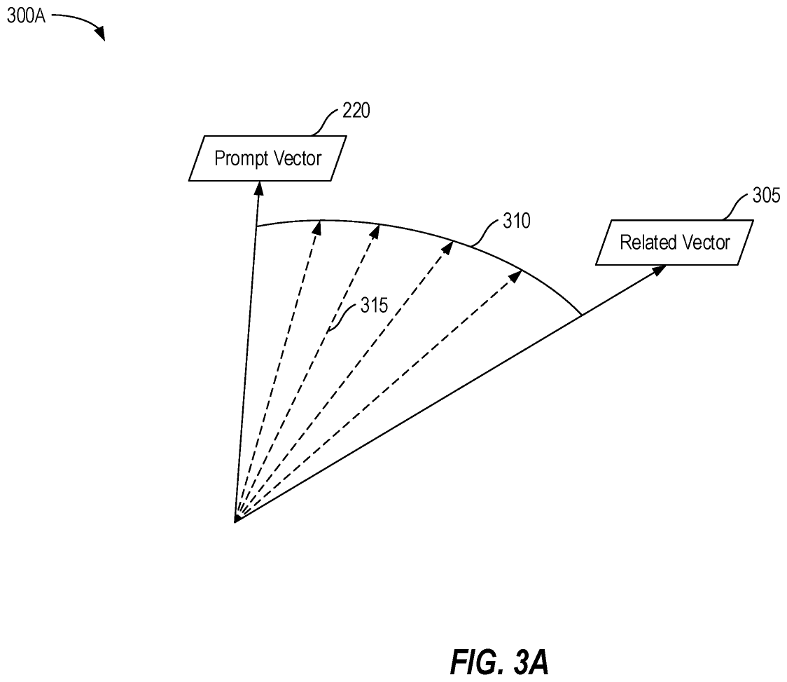

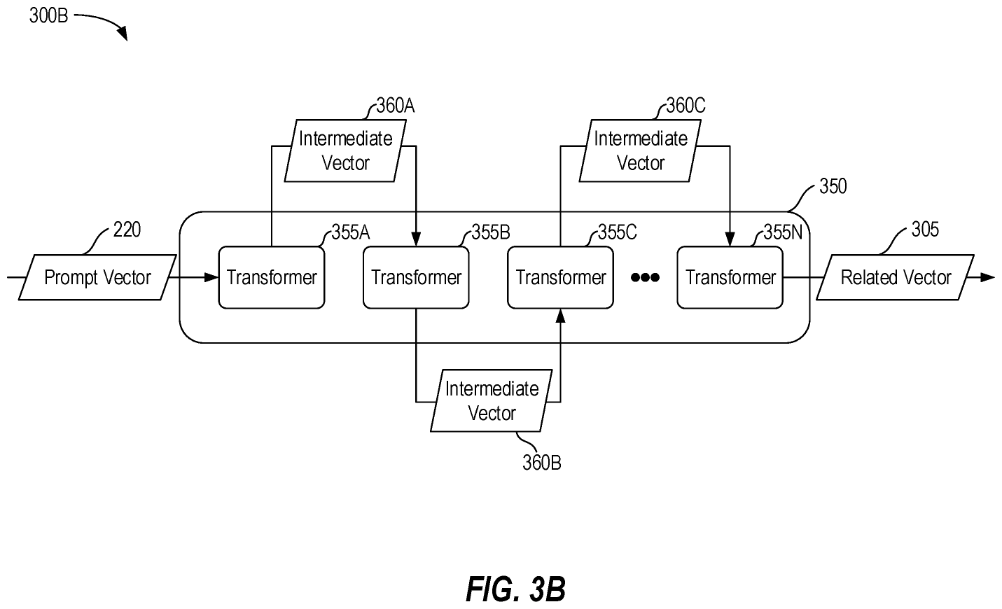

FIG. 3A depicts an example workflow 300A for generating a sequence of vectors based on a prompt word and a related word, according to one embodiment disclosed herein. In some embodiments, the workflow 300A can be used during a training process to provide vector sequences. For example, the workflow 300A may be implemented by one or more hardware or software components, such as the prompt vector augmentation code 200 of FIG. 1, to train one or more models to generate augmented prompt vectors. In some embodiments, a first system or component (referred to in some embodiments as a training system) may train the model(s), while a second system or component (referred to in some embodiments as an inferencing system) may use the trained model(s) during runtime to generate model output. In some embodiments, a single system may act as both the training system and the inferencing system.

In some embodiments, after obtaining the most relevant word(s) to the prompt word in the context text, the training system can convert the prompt word and the related word into vectors (e.g., by processing each with an encoder, such as the encoder 215 of FIG. 2). In some embodiments, the prompt word vector and related word vector can then be projected or mapped into the multidimensional vector space, and the cosine similarity between them can be computed (e.g., a number between 0 and 1). As discussed in more detail below, a gap space between the calculated cosine similarity and a value of one (e.g., between the prompt vector and the related vector) may be used as a sampling space, and random sampling can be performed (in some cases, using drop out). As discussed in more detail below, these sampled vectors can be conceptualized as representative of words between the prompt word and related word in the semantic vector space, and these representational vectors can therefore represent the evolution from the prompt word to the related word in the vector dimension. These representational vectors may therefore be ordered or ranked in order of cosine similarity to the prompt word, a transformer sequence model can be used to model this process in sequence order (e.g., to train the sequence model), as discussed in more detail below.

In the illustrated example, the prompt vector 220 (which is generated based on the prompt word) and a related vector 305 (generated by processing the related word 235 of FIG. 2 using the encoder) are projected/mapped into the vector space. In the illustrated example, the arc 310 represents the gap or semantic space between the prompt word (represented by the prompt vector 220) and the related word (represented by the related vector 305). That is, the values/vectors along this arc 310 may effectively represent words with a meaning that is between the prompt word and related word. It should be understood that, in some embodiments, these intermediate vectors may not represent actual/real words. Instead, they are vectors representing the semantics/meanings between the actual/real prompt word and related word.

As illustrated by dashed arrows 315, the training system may select a number of vector samples on the arc 310 (e.g., using random sampling). In some embodiments, the training system uses random sampling with dropout to sample or extract these vectors. In some embodiments, as discussed above, each of these sampled vectors (depicted by dashed arrows 315) may represent semantics or meanings between the prompt word and related word. In some embodiments, these sampled vectors are referred to as “intermediate” vectors.

In some embodiments, the number of intermediate vectors that are sampled may vary depending on the particular implementation. For example, the training system may determine the number to sample based on the number of stages in the sequence generation model, discussed in more detail below. In an embodiment, once the desired number of intermediate vectors have been sampled along the arc 310, the training system can sort or order them based on their cosine similarity to the prompt word, thereby creating a sequence of vectors. For example, the sequence may begin with the prompt vector 220, followed by the ordered set of intermediate vectors (beginning with the intermediate vector that is most similar to the prompt vector 220 and ending with the intermediate vector that is most dissimilar to the prompt vector 220 and/or most similar to the related vector 305), and finally ended with the related vector 305.

As discussed below in more detail, this sequence of vectors can then be used to train a sequence generation model. After training, the sequence generation model may be used to generate an augmented prompt vector, as discussed in more detail below.

As discussed above, although the illustrated example suggests generation/output of a single sequence of vectors based on a single prompt vector 220 and related vector 305, in some embodiments, the workflow 300A may be performed multiple times (in sequence or in parallel) to generate multiple such vector sequences, one for each prompt word. That is, for a set of training data (e.g., a set of records, each including a prompt word 205 and context 210), the workflow 300A may be used during a training phase to generate a corresponding vector sequence which can then be used to train a sequence generation model, as discussed in more detail below.

FIG. 3B depicts an example workflow 300B for training a sequence generation model using a sequence of vectors, according to one embodiment disclosed herein. In some embodiments, the workflow 300B can be used during a training process to use vector sequences to train the sequence generation model. For example, the workflow 300B may be implemented by one or more hardware or software components, such as the prompt vector augmentation code 200 of FIG. 1, to train one or more models to generate augmented prompt vectors. In some embodiments, a first system or component (referred to in some embodiments as a training system) may train the model(s), while a second system or component (referred to in some embodiments as an inferencing system) may use the trained model(s) during runtime to generate model output. In some embodiments, a single system may act as both the training system and the inferencing system.

In some embodiments, the generated vector sequences are used to train a sequence generation model. This sequence generation model can then dynamically generate a prompt vector according to the context, whose input is the text of the context spliced/concatenated with the text of the prompt word, and whose output is a hidden vector (e.g., a vector of prompts with high robustness). As discussed in more detail below, this augmented prompt vector differs from the original prompt word/vector. For example, the augmented vector may be a highly robust prompt vector with multilingual semantics and high-density information interaction with the context text, which can obviate the conventional problem of the prompt process/language model being hyper-sensitive to single semantics/the specific prompt word.

In the illustrated workflow 300B, a sequence of vectors (including prompt vector 220, intermediate vectors 360A, 360B, and 360C, and related vector 305) is used to train the sequence generation model 350. As illustrated, the sequence generation model 350 may comprise a sequence of transformers 355A-N. As indicated by the ellipsis, there may be any number of transformers 355 in the architecture. In some embodiments, as discussed above, the length of the vector sequence may be determined based on the number of transformers 355 in the model.

As depicted, the output of each transformer 355 in the sequence generation model 350 can generally be used as the input of the subsequent transformer 355. For example, the second transformer 355B receives input from the first transformer 355A and outputs/generates the input to the third transformer 355C. During training, each transformer 355 seeks/learns to generate the next vector in the vector sequence based on a current vector in the sequence.

Specifically, given the first vector in the vector sequence (the prompt vector 220), the first transformer 355A tries to generate the next vector in the sequence (the intermediate vector 360A). Given this second vector in the vector sequence (the intermediate vector 360A), the next transformer 355B tries to generate the subsequent vector in the sequence (the intermediate vector 360C). This continues until the final transformer 355N receives the penultimate vector in the sequence (the intermediate vector 360C) and uses it to generate the final vector in the sequence (the related vector 305).

That is, during training, the parameters of each transformer 355 can be refined or updated to improve the accuracy of its generated output (e.g., to increase the similarity between the generated vectors and the sampled intermediate vectors in the sequence of vectors). As discussed above, although the illustrated example suggests training the sequence generation model 350 using a single sequence of vectors, in some embodiments, the workflow 300B may be performed multiple times (in sequence or in parallel) to train based on multiple such vector sequences. In an embodiment, once trained, the sequence generation model 350 can be used to generate augmented prompt vectors, as discussed below in more detail.

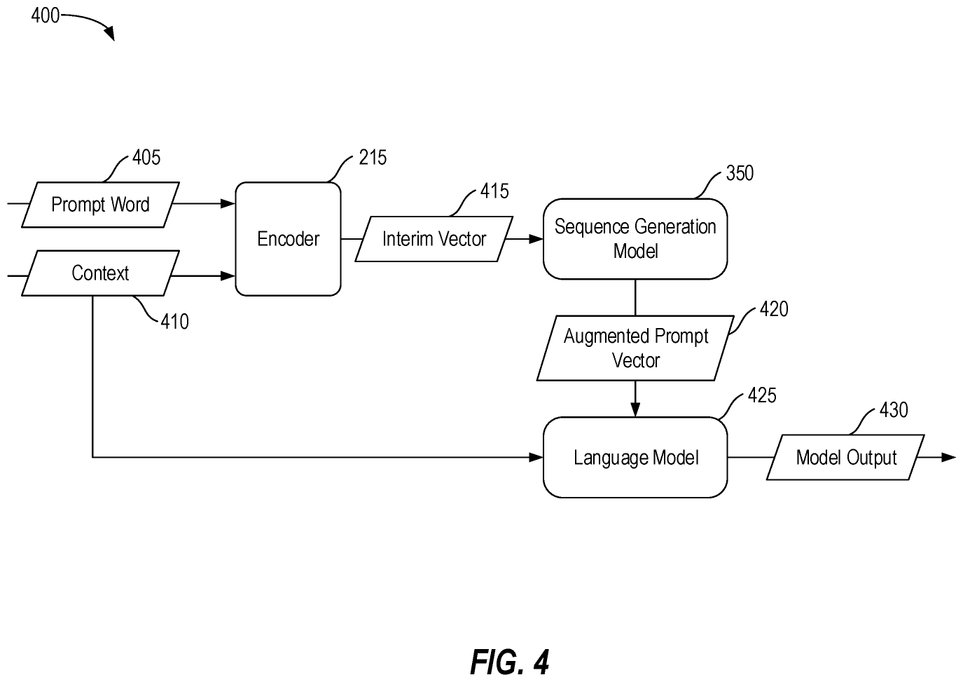

FIG. 4 depicts an example workflow 400 for generating augmented prompt vectors and language model output, according to one embodiment disclosed herein. In some embodiments, the workflow 400 can be used during an inferencing process to use a trained sequence generation model and language model to generate output. For example, the workflow 400 may be implemented by one or more hardware or software components, such as the prompt vector augmentation code 200 of FIG. 1, to use one or more models to generate augmented prompt vectors and language model output. In some embodiments, a first system or component (referred to in some embodiments as a training system) may train the model(s), while a second system or component (referred to in some embodiments as an inferencing system) may use the trained model(s) during runtime to generate model output. In some embodiments, a single system may act as both the training system and the inferencing system.

In the illustrated workflow 400, during runtime, a prompt word 405 and context 410 are accessed. As used herein, “accessing” data can generally include retrieving, receiving, requesting, or otherwise gaining access to the data. For example, a user or another computer component may provide the prompt word 405 and context 410. As discussed above, the prompt word 405 can generally correspond to a textual word or phrase (e.g., natural language text) to be used to prompt a language model to generate output. Similarly, the context 210 can generally correspond to text data (e.g., natural language text) to be searched/evaluated based on the prompt word 405 (e.g., using a language model) to generate output.

As illustrated, during runtime, the prompt word 405 and context 410 are each provided to an encoder 215 to generate one or more vector representations. In some embodiments, as discussed above, the encoder 215 may correspond to a pretrained encoder (e.g., a portion of a language translation model). In some embodiments, the prompt word 405 and context 410 are concatenated prior to being provided as input to the encoder 215. In at least one embodiment, a separator token may be used to delineate the concatenated prompt word 405 and context 410. That is, the prompt word 405 and context 410 may be concatenated to form a single string of text, with a separator token between them.

As illustrated, the encoder 215 generates an interim vector 415 based on the input prompt word 405 and context 410. The interim vector 415 is then provided as input to a sequence generation model 350. As discussed above, the sequence generation model 350 (which was trained on sequences of vectors) can receive this interim vector 415 and generate an augmented prompt vector 420. In some embodiments, the augmented prompt vector 420 is generated based on the state/vector generated at each step of the sequence generation model 350 (e.g., the output of each transformer).

That is, in some embodiments, the augmented prompt vector 420 is generated by aggregating the vector that is generated/output by each transformer in the sequence generation model 350 (such as by summing these vectors, concatenating them, and the like). In some embodiments, rather than a single augmented prompt vector 420, the sequence generation model 350 outputs a sequence of vectors to be used collectively as the augmented prompt vector 420.

In an embodiment, the augmented prompt vector 420 mirrors or mimics a sequence of vectors (e.g., a sequence starting from the prompt vector and moving towards the related word, as discussed above). As discussed above, this augmented prompt vector 420 may be a highly robust vector with multilingual semantics (e.g., imparted by the encoder 215) and/or high-density information interaction with the context text (e.g., imparted by the sequence generation model 350).

As illustrated, the augmented prompt vector 420 can thereafter be provided as input to a language model 425 (e.g., a pretrained model, as discussed above). That is, the augmented prompt vector 420 can itself be used as the prompt, rather than using the prompt word 405 directly. Additionally, as illustrated, the context 410 is similarly provided as input to the language model 425. The language model 425 generates model output 430 based on these inputs. In some embodiments, the language model 425 may be referred to as a language machine learning model.

As discussed, the particular content and structure of the model output 430 may vary depending on the particular implementation. As one example, in some embodiments, the language model 425 may be an information extraction model. In one such embodiment, the model output 430 may correspond to text (from the context 410) that is identified/extracted based on the prompt word 405. For example, if the context 410 includes “antibiotics: 30 mg” and the prompt word 405 is “dosage,” the model output 430 may indicate the dosage (e.g., “30 mg”). In some embodiments, the model output 430 may additionally or alternatively include other information, such as the location(s) in the context 410 where the output was found (e.g., indicating the character number(s)), the confidence or probability that the extracted information is accurate, and the like.

The model output 430 can generally be used for a wide variety of purposes, depending on the particular implementation. Advantageously, by generating and using the augmented prompt vector 420 (rather than using the prompt word 405 itself), the model output 430 may generally be higher quality (e.g., more accurate or complete) and/or more stable (e.g., less prone to changes based on the specific prompt word 405 used). Further, by using the augmented prompt vector 420, the inferencing system can avoid repeatedly/iteratively processing multiple prompt words 405 to ensure that all relevant information is identified. This can substantially reduce the computational resources needed to generate the model output 430 (e.g., reducing the latency, memory requirements, energy consumption, and the like).

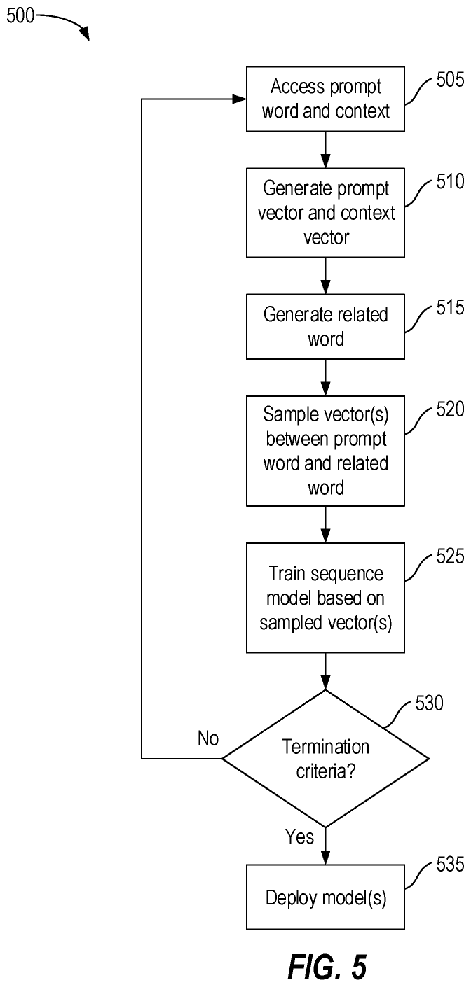

FIG. 5 is a flow diagram depicting an example method 500 for training machine learning models to generate augmented prompt vectors, according to one embodiment disclosed herein. In some embodiments, the method 500 can be used during a training process to train a sequence generation model. For example, the method 500 may be implemented by one or more hardware or software components, such as the prompt vector augmentation code 200 of FIG. 1, to train one or more models to generate augmented prompt vectors. In some embodiments, a first system or component (referred to in some embodiments as a training system) may train the model(s), while a second system or component (referred to in some embodiments as an inferencing system) may use the trained model(s) during runtime to generate model output. In some embodiments, a single system may act as both the training system and the inferencing system.

At block 505, the training system accesses a prompt word and corresponding context data. For example, from a corpus of training data (e.g., a set of records, each containing a prompt word and context data), the training system may select or access one such record to train the model(s). In embodiments, the training system may access the records using any suitable criteria or techniques (including randomly or pseudo-randomly). Although depicted as a sequential process for conceptual clarity (e.g., where each prompt word is accessed/evaluated in turn), in some embodiments, the training system may access/use multiple training records in parallel.

As discussed above the prompt word can generally correspond to a textual word or phrase (e.g., natural language text) to be used to prompt a language model to generate output. For example, the prompt word may correspond to the prompt word 205 of FIG. 2. Similarly, the context data can generally correspond to text data (e.g., natural language text) to be searched/evaluated based on the prompt word (e.g., using a language model) to generate output. For example, the context data may correspond to the context 210 of FIG. 2.

At block 510, the training system generates a prompt vector and a context vector based on the prompt word and context data, respectively. For example, as discussed above, the training system may process each using a pretrained encoder (e.g., a portion of a multilanguage translation model) to generate the vectors. In at least one embodiment, the encoder corresponds to the encoder 215 of FIG. 2.

At block 515, the training system generates a related word based on the prompt vector and context vector. For example, as discussed above, the training system may use one or more attention mechanisms or models to identify one or more words, reflected in the context data/context vector, that are similar or related to the prompt word/prompt vector. In some embodiments, the training system uses the attention mechanism 230 of FIG. 2 to generate the related word. In at least one embodiment, the related word corresponds to the related word 235 of FIG. 2.

At block 520, the training system samples one or more vectors between the prompt word and the related word in a multidimensional vector space, as discussed above. For example, the training system may generate a vector for the related word (e.g., using the encoder) and project or map the prompt vector and related vector into the vector space. The training system may then sample vector(s) (e.g., intermediate vectors) between these (e.g., as indicated by arc 310 of FIG. 3A).

In some embodiments, as discussed above, the training system can then order or sort these sampled intermediate vectors based on their similarity to the prompt vector to generate a sequence of vectors that begins with the prompt vector and ends with the related vector.

At block 525, the training system trains a sequence generation model based on the sequence of sampled vectors, as discussed above. For example, the sequence generation model may include a machine learning architecture that generates a set of output vectors based on an input vector. For example, as discussed above with reference to FIG. 3B, the prompt vector may be provided as input to the sequence generation model 350 (e.g., to a first transformer 355A) to generate an intermediate vector. This generated vector can be compared against the actual next vector (e.g., the first intermediate vector 360A in the sequence of vectors) to refine the parameters of the first transformer. This process can be repeated for each transformer or step in the sequence generation model.

At block 530, the training system then determines whether one or more termination criteria are met. Generally, the termination criteria can include a wide variety of considerations, such as determining whether any additional training data remains, determining whether a defined number of iterations or epochs have been performed, determining whether a defined amount of computing resources and/or time have been spent, and the like.

If the termination criteria are not satisfied, the method 500 returns to block 505. If one or more of the termination criteria are met, the method 500 continues to block 535. At block 535, the training system deploys the model(s) for inferencing. Generally, deploying the models can include a wide variety of operations, such as transmitting or indicating the parameter(s) of the model(s) to another system (e.g., an inferencing system), instantiating the model(s) locally, and the like.

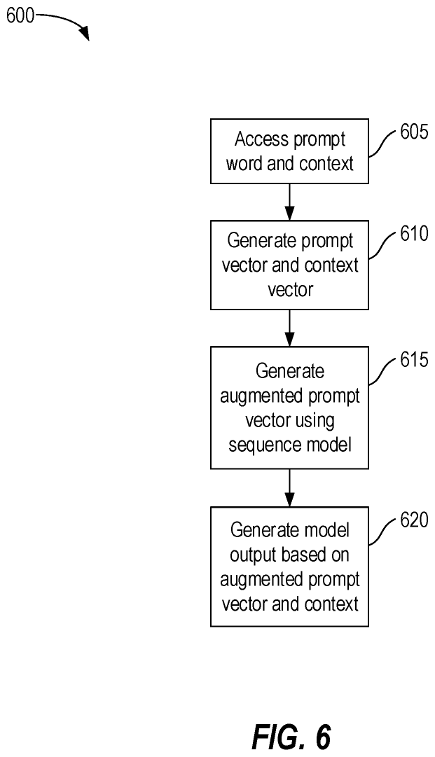

FIG. 6 is a flow diagram depicting an example method 600 for using machine learning models to generate augmented prompt vectors and language model output, according to one embodiment disclosed herein. In some embodiments, the method 600 can be used during an inferencing process to use a trained sequence generation model and language model to generate output. For example, the method 600 may be implemented by one or more hardware or software components, such as the prompt vector augmentation code 200 of FIG. 1, to use one or more models to generate augmented prompt vectors and language model output. In some embodiments, a first system or component (referred to in some embodiments as a training system) may train the model(s), while a second system or component (referred to in some embodiments as an inferencing system) may use the trained model(s) during runtime to generate model output. In some embodiments, a single system may act as both the training system and the inferencing system.

At block 605, the inferencing system accesses a prompt word and context data. For example, the inferencing system may receive the prompt word and context data from a user or from another computing component during runtime. As discussed above the prompt word can generally correspond to a textual word or phrase (e.g., natural language text) to be used to prompt a language model to generate output during runtime. For example, the prompt word may correspond to the prompt word 405 of FIG. 4. Similarly, the context data can generally correspond to text data (e.g., natural language text) to be searched/evaluated based on the prompt word (e.g., using a language model) to generate output during runtime. For example, the context data may correspond to the context 410 of FIG. 4.

At block 610, the inferencing system generates a prompt vector and a context vector based on the prompt word and context data, respectively. For example, as discussed above, the training system may process each using a pretrained encoder (e.g., a portion of a multilanguage translation model) to generate the vectors. In at least one embodiment, the encoder corresponds to the encoder 215 of FIG. 4.

At block 615, the inferencing system generates an augmented prompt vector by processing the prompt vector and context vector using a trained sequence generation model. For example, as discussed above, the inferencing system may concatenate or splice the prompt vector and context vector (in some cases, including a separation token between the two vectors) and process this vector using the sequence generation model discussed above. In some embodiments, as discussed above, the augmented prompt vector may correspond to or be generated based on the outputs of each transformer in the sequence generation model. In at least one embodiment, the sequence generation model corresponds to the sequence generation model 350 of FIG. 4. In some embodiments, the augmented prompt vector corresponds to the augmented prompt vector 420 of FIG. 4.

At block 620, the inferencing system generates model output using a (pretrained) language model based on the augmented prompt vector and the context data. For example, as discussed above, the model output may correspond to model output 430 of FIG. 4, and the language model may correspond to language model 425 of FIG. 4. As discussed above, the particular content and structure of the model output may vary depending on the particular implementation.

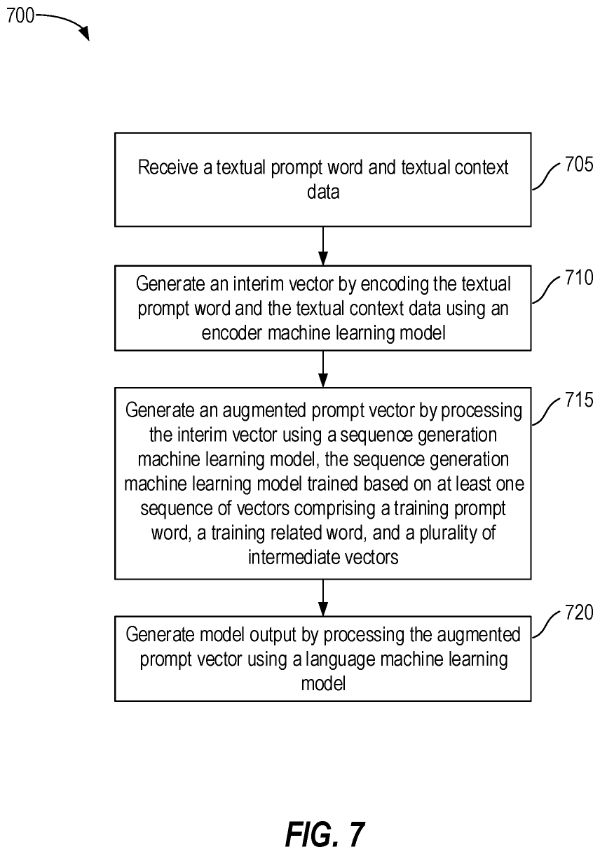

FIG. 7 is a flow diagram depicting an example method 700 for generating augmented prompt vectors and language model output, according to one embodiment disclosed herein. In some embodiments, the method 700 can be used during an inferencing process to use a trained sequence generation model and language model to generate output. For example, the method 700 may be implemented by one or more hardware or software components, such as the prompt vector augmentation code 200 of FIG. 1, to use one or more models to generate augmented prompt vectors and language model output. In some embodiments, a first system or component (referred to in some embodiments as a training system) may train the model(s), while a second system or component (referred to in some embodiments as an inferencing system) may use the trained model(s) during runtime to generate model output. In some embodiments, a single system may act as both the training system and the inferencing system.

At block 705, a textual prompt word (e.g., prompt word 405 of FIG. 4) and textual context data (e.g., context 410 of FIG. 4) are received.

At block 710, an interim vector (e.g., interim vector 415 of FIG. 4) is generated by encoding the textual prompt word and the textual context data using an encoder machine learning model (e.g., encoder 215 of FIG. 4).

At block 715, an augmented prompt vector (e.g., augmented prompt vector 420 of FIG. 4) is generated by processing the interim vector using a sequence generation machine learning model (e.g., sequence generation model 350 of FIG. 4), the sequence generation machine learning model trained based on at least one sequence of vectors comprising a training prompt vector (e.g., prompt vector 220 of FIGS. 3A and 3B), a training related vector (e.g., related vector 305 of FIGS. 3A and 3B), and a plurality of intermediate vectors (e.g., intermediate vectors 360A-C of FIG. 3B).

At block 720, model output (e.g., model output 430 of FIG. 4) is generated by processing the augmented prompt vector using a language machine learning model (e.g., language model 425 of FIG. 4).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

While the foregoing is directed to embodiments of the present invention, other and further embodiments of the invention may be devised without departing from the basic scope thereof, and the scope thereof is determined by the claims that follow.

What is claimed is:

1. A method, comprising:
receiving a textual prompt word and textual context data;
generating an interim vector by encoding the textual prompt word and the textual context data using an encoder machine learning model;
generating an augmented prompt vector by processing the interim vector using a sequence generation machine learning model, the sequence generation machine learning model trained based on at least one sequence of vectors comprising a training prompt word, a training related word, and a plurality of intermediate vectors; and
generating model output by processing the augmented prompt vector using a language machine learning model.

2. The method of claim 1, wherein the encoder machine learning model was trained during training of a translation machine learning model, the translation machine learning model comprising the encoder machine learning model and a decoder machine learning model.

3. The method of claim 2, wherein the translation machine learning model is a multilingual translation model.

4. The method of claim 1, wherein generating the model output further comprises processing the textual context data using the language machine learning model.

5. The method of claim 1, further comprising:
generating the at least one sequence of vectors; and
training the sequence generation machine learning model based at least in part on the at least one sequence of vectors.

6. The method of claim 5, wherein generating the at least one sequence of vectors comprises:
mapping the training textual prompt word and the training related word in a vector space, and
sampling one or more vectors from the vector space between the mapped training textual prompt word and the mapped training related word.

7. The method of claim 5, further comprising generating the training related word by processing the training textual prompt word and the training textual context data using an attention mechanism.

8. A system, comprising:
one or more computer processors; and
a memory containing a program which when executed by the one or more computer processors performs an operation, the operation comprising:
receiving a textual prompt word and textual context data;
generating an interim vector by encoding the textual prompt word and the textual context data using an encoder machine learning model;
generating an augmented prompt vector by processing the interim vector using a sequence generation machine learning model, the sequence generation machine learning model trained based on at least one sequence of vectors comprising a training prompt word, a training related word, and a plurality of intermediate vectors; and
generating model output by processing the augmented prompt vector using a language machine learning model.

9. The system of claim 8, wherein the encoder machine learning model was trained during training of a translation machine learning model, the translation machine learning model comprising the encoder machine learning model and a decoder machine learning model.

10. The system of claim 9, wherein the translation machine learning model is a multilingual translation model.

11. The system of claim 8, wherein generating the model output further comprises processing the textual context data using the language machine learning model.

12. The system of claim 8, the operation further comprising:
generating the at least one sequence of vectors; and
training the sequence generation machine learning model based at least in part on the at least one sequence of vectors.

13. The system of claim 12, wherein generating the at least one sequence of vectors comprises:
mapping the training textual prompt word and the training related word in a vector space, and
sampling one or more vectors from the vector space between the mapped training textual prompt word and the mapped training related word.

14. The system of claim 12, further comprising generating the training related word by processing the training textual prompt word and the training textual context data using an attention mechanism.

15. A computer program product comprising a computer-readable storage medium having computer-readable program code embodied therewith, the computer-readable program code executable by one or more computer processors to perform an operation comprising:
receiving a textual prompt word and textual context data;
generating an interim vector by encoding the textual prompt word and the textual context data using an encoder machine learning model;
generating an augmented prompt vector by processing the interim vector using a sequence generation machine learning model, the sequence generation machine learning model trained based on at least one sequence of vectors comprising a training prompt word, a training related word, and a plurality of intermediate vectors; and
generating model output by processing the augmented prompt vector using a language machine learning model.

16. The computer program product of claim 15, wherein the encoder machine learning model was trained during training of a translation machine learning model, the translation machine learning model comprising the encoder machine learning model and a decoder machine learning model.

17. The computer program product of claim 15, wherein generating the model output further comprises processing the textual context data using the language machine learning model.

18. The computer program product of claim 15, the operation further comprising:
generating the at least one sequence of vectors; and
training the sequence generation machine learning model based at least in part on the at least one sequence of vectors.

19. The computer program product of claim 18, wherein generating the at least one sequence of vectors comprises:
mapping the training textual prompt word and the training related word in a vector space, and
sampling one or more vectors from the vector space between the mapped training textual prompt word and the mapped training related word.

20. The computer program product of claim 18, further comprising generating the training related word by processing the training textual prompt word and the training textual context data using an attention mechanism.
